(19) United States
(12) Patent Application Publication
(10) Pub. No.: US 2023/0002198 A1
(43) Pub. Date: Jan. 5, 2023

(54) METHOD FOR ERECTING A SUPPORTING STRUCTURE OF AN ESCALATOR OR A MOVING WALKWAY

(71) Applicant: INVENTIO AG, Hergiswil (CH)

(72) Inventors: Georg Wagenleitner, Roßleithen (AT); Gilbert Zimmermann, Stansstad (CH)

(21) Appl. No.: 17/782,514

(22) PCT Filed: Nov. 27, 2020
(86) PCT No.: PCT/EP2020/083598

§ 371 Date: Jun. 3, 2022

(30) Foreign Application Priority Data
Dec. 5, 2019 (EP) 19213941.8

(51) Int. Cl. B66B 23/00; B23K 31/02; B25J 11/00

(52) U.S. Cl. CPC B66B 23/00; B23K 31/02; B25J 11/005; B23K 2101/24

(57) ABSTRACT

The disclosure relates to a method for erecting a supporting structure of a passenger transport system configured as an escalator or moving walkway. The supporting structure is constructed between two support points of an existing structure using a 3D welding robot system by depositing welding material.

### TECHNICAL FIELD

This disclosure relates to a method for erecting a supporting structure of a passenger transport system configured as an escalator or moving walkway, and to a passenger transport system having a supporting structure manufactured according to this method.

### SUMMARY

Passenger transport systems, which can be configured as escalators or as moving walkways, are used in structures in the public sector, for example, in train stations, subway stations and airports as well as in shopping malls, cultural centers and the like. Escalators or moving walkways have a load-bearing structure, which can be referred to as a supporting structure. In most cases, this supporting structure is a framework structure which comprises metal profiles welded together and is produced by the manufacturer as a complete unit or divided into supporting structure modules. The production of such a supporting structure using a welding robot system is disclosed, for example, in US 2019/134753 A1.

The supporting structure or the supporting structure modules or framework modules thereof are installed in a structure with the supporting structure connecting two floors of the structure, for example. The movable components of the escalator or moving walkway, for example, a step belt or a pallet belt, circulating handrail belts, deflection axles, a drive shaft and parts of the drive motor and transmission, and the like, are arranged in this supporting structure. Furthermore, stationary components such as balustrades, comb plates, bearing points, raceways and guide rails, a controller, monitoring systems and safety systems and the like are also fixedly connected to the supporting structure. If the supporting structure is subdivided into supporting modules, each separation point formed thereby results in a considerable increase in material, manufacturing time and assembly time. For this reason, separation points are avoided as far as possible or their number is kept as small as possible, which means that the supporting structure or the supporting structure modules thereof usually have very large dimensions.

Escalators and moving walkways of the aforementioned type or the modules thereof are therefore large, bulky parts which, due to their structure, cannot be introduced into a structure in an arbitrarily disassembled manner. As mentioned above, the supporting structure accommodates all the components of the escalator and supports said components at two opposing support points in the structure. In other words, this means that the supporting structure extends over the entire planned length of the passenger transport system.

In the case of new structures to be constructed, the escalators and moving walkways are usually used during the construction process as soon as the support points thereof that are constructed on the structure are available, and surrounding walls and ceilings of higher floors are then further constructed. This is because these passenger transport systems are, for the aforementioned reasons, installed in the structure as very large components and are so large that it would be difficult to introduce them into the structure through existing openings.

In the case of existing structures, however, it is not possible to introduce a large escalator or moving walkway into the structure without demolishing parts of the structure shell, for example, the walls or ceilings, to create openings in order to introduce the large components. This problem may also occur in subway stations because tunnels are constructed underground, and the escalators and moving walkways have to be installed in these tunnels.

The transport of such passenger transport systems which are completely assembled in the manufacturing plant and delivered as a whole constitutes another problem. Large trucks have to be used in this case, and the large volume of these systems may mean that traffic routes have to be blocked during transport and certain traffic obstructions have to be accepted. Ultimately, these problems lead to very high transport and installation costs.

In order to prevent the problems listed above, passenger transport systems of the aforementioned type are often introduced into the structure in a disassembled state and are only assembled in the structure. However, there is then the problem that the supporting structure, which is usually designed as a framework and is the largest part of an escalator or moving walkway, cannot be disassembled arbitrarily. Even if the supporting structure is delivered disassembled into two or three sections and brought into the structure, it is still possible that certain parts of the structure have to be demolished as a result. In addition, each interface of the supporting structure on which the sections are assembled requires considerable additional effort, since this interface has to be particularly reinforced in order for the interface to have the same load-bearing capacity as the other parts of the supporting structure.

Because of these problems, the problem addressed by the present disclosure can be considered that of providing possibilities for bringing a supporting structure into an existing building or structure without parts of the structure having to be demolished or without the supporting structure having to be introduced into the structure in sections.

This problem can be solved by a method for erecting a supporting structure of a passenger transport system configured as an escalator or moving walkway. The method can be characterized by the fact that the supporting structure is constructed between two support points of an existing structure using a 3D welding robot system. For this purpose, the 3D welding robot system has at least one controller having 3D robot control software, a traveling device having a 3D welding robot and a welding material feed device. A component model data set, which digitally maps the supporting structure to be erected, is converted into welding operations by means of the 3D robot control software. These operations are to be carried out by the 3D welding robot during the erection phase of the supporting structure, such that, during the erection phase, the supporting structure is produced between the two support points by means of the 3D welding robot system by depositing welding material. In addition, fastening regions for further components of the passenger transport system and/or bedding for guide rail inserts are also formed on the supporting structure during the production thereof. Extremely precise interfaces which require little or no reworking can thus be produced for the additional components of the passenger transport system that are to be attached.

For example, known industrial welding robots, the deposition welding module of which can be pivoted about a plurality of axes and which is mounted on a traveling device, can be used as 3D welding robots. The deposition welding module in this case deposits layer by layer of welding material, such that a three-dimensional workpiece is gradually produced from the welding material. The traveling device is used to move the 3D welding robot back and forth between the two support points in a guided manner, or to move said robot, since the 3D welding robot has only a limited action range and the supporting structures to be produced are usually very long structures.

In other words, a comparatively convenient 3D welding robot system having the components listed above can be introduced into the structure through existing openings, and the supporting structure of the passenger transport system can be erected at the intended installation site by means of said system.

In order to simplify the production, a starting body can be present as part of the supporting structure to be constructed, which starting body is arranged at one of the two support points or between the two support points of the existing structure at the start of the erection of the supporting structure. The starting body preferably has the same material properties as the welding material to be deposited by the 3D welding robot system. A variety of metals, in particular, steel, but also other suitable, weldable materials such as, for example, high-strength plastics materials, can be used as materials. The starting body can be, for example, a flat plate, a profile bar, a beam embedded in the structure, a remaining support of the supporting structure provided between the two support points, and the like. The starting body can easily be integrally joined to the welding material to be deposited. The 3D welding robot then deposits the welding material, starting at the starting body, and thus builds up the supporting structure.

In one embodiment of the method, the contours of the supporting structure that are first formed during the erection phase can be fixed to the structure by means of a fixing device. If a starting body is used, it can preferably be fixed to the structure by means of a fixing device. This has the advantage that the contours of the framework that have already been produced by the method are temporarily fixedly connected to the structure and thus have a stable basis for the erection process. In this way, forces and torques which are caused by the 3D welding robot and overhanging contours of the supporting structure and, during the erection, act on the supporting structure which is not yet completed can be effectively supported on the structure. As soon as the supporting structure is completed and stably supported by the two support points, the fixing device or parts thereof can be removed.

In a further embodiment of the method, the 3D welding robot system can comprise a 3D scanner and at least one reference mark. By means of the 3D scanner, the exact contours of the support points and the installation space between the two support points can be recorded before the construction of the supporting structure begins and, based on this actual data, corrections can already be made to the digital component model data set of the supporting structure if necessary. The reference mark is preferably arranged at one of the two support points, the 3D scanner, continuously or at discrete time intervals, recording the contours of the supporting structure produced during the erection, together with the reference marking, and forwarding them to the controller as actual data. Corrections can then be made to the welding operations of the 3D welding robot that are specified by the 3D robot control software by processing the actual data in the controller. Such corrections are particularly necessary if, as described below, the traveling device having the 3D welding robot is not guided on the supporting structure being produced, but on a guide device which is arranged separately therefrom and can be set up temporarily.

In a further embodiment of the method, the 3D welding robot system can comprise a further reference mark which is arranged at the other of the two support points, which further reference mark is also recorded by the 3D scanner. The additional recording of the second reference mark and, of course, the position evaluation thereof can significantly increase precision when recording actual data, since this eliminates the need for precise positioning of the 3D scanner relative to just one reference mark, and the contours of the supporting structure being produced represent actual values, which are calculated as point coordinates using conventional triangulation algorithms and can be compared with the point coordinates specified by the digitally mapping component model data set.

In a further embodiment of the method, the 3D welding robot system can comprise a guide device which can be set up temporarily and is arranged between the two support points during the production of the supporting structure and on which the traveling device is guided. As a result, only the dead weight of the already produced contours of the supporting structure acts on said contours, such that load-related deviations only occur to a very small extent.

Alternatively, a track can also be formed on the supporting structure when said structure is produced, which track is used to guide the traveling device. This variant can be used, for example, in this case of very low ceiling heights or if there are no suitable connection points for the guide device on the structure, as can be the case with atriums or glass buildings.

Due to the deposition welding process, which the 3D welding robot implements with the welding operations thereof, the surface of the track produced in this way can be too rough to be able to guide the traveling device effectively. It may therefore be necessary, for example, to periodically grind the track surfaces by means of grinding operations. Alternatively, guide rail inserts such as flat steel profiles can also be used, which inserts are continuously incorporated into the supporting structure being produced by the welding operations. This track can optionally also be used later for guiding the conveyor belt of the completed passenger transport system.

In a further embodiment of the method, receptacles for tensioning elements can also be formed on the supporting structure during the production thereof. The tensioning elements can be provided wherever tensile forces prevail in the finished structure, such as in the region of the underside of the supporting structure. In this case, the receptacles can be formed, for example, in the regions of the support points on the supporting structure. At least after the receptacles have been produced, the tensioning elements can be arranged between the receptacles and tensioned, or the associated region of the supporting structure can be braced. In other words, the regions of the supporting structure that are subjected to tensile loads are preloaded by the tension members arranged parallel thereto, such that tensile forces which are at least reduced prevail in these regions of the supporting structure after completion.

In a further embodiment of the method, the already produced portion of the supporting structure can be supported in the structure by means of supports and/or suspension devices during the production. If necessary, the supports or suspension devices can be adapted to the continuously changing mass of the supporting structure during the production process, such that there is no positional displacement as a result of increasing mass of the already produced contours of the supporting structure relative to the structure.

The supports and/or suspension devices can, in this case, be produced as an integral component of the completed supporting structure by means of the 3D welding robot, or, provided as additional components, can be integrally joined to the already produced portion of the supporting structure by the 3D welding robot. Of course, the supports and/or suspension devices can also only be used temporarily to support the already produced regions of the supporting structure, in that they are removed again after the completion of the supporting structure, which is then supported by the two support points of the structure. Of course, if the supporting structure produced has a particularly long span between the two support points, one or more of the supports can be left. These are preferably configured as floating bearing points, such that movements between different floors of the structure, such as can occur as a result of earthquakes, are decoupled from the supporting structure. In rare cases, however, it can also be desirable for the supporting structure to increase the rigidity of the surrounding structure. For this purpose, the supporting structure can be rigidly connected to the structure at the support points and, if necessary, also via additional supports. In this case, support points having an exposed beam made of material which can be joined to the welding material, which beam, as already mentioned above, can be used as a starting body, are particularly advantageous.

In a further embodiment of the method, “only” a supporting structure designed as a metal reinforcement can be produced by means of the 3D welding robot system. In other words, the 3D welding robot only produces the contours of the metal supporting structure that have to absorb tensile forces or bending moments, and the contours that are required for the temporary stabilization of the processable concrete to be applied afterward. Interfaces between the supporting structure and the structure, such as, for example, support brackets or supports supported at the support points can also be part of this supporting structure designed as a metal reinforcement. The regions of the supporting structure that are used as the metal reinforcement are then at least partially enclosed by a concrete mass. Although this production requires two production passes, i.e., the first to produce the metal reinforcement and the second to apply the processable concrete mass, it is advantageous in that the manufacturing costs can be significantly reduced due to the partial replacement of welding material with concrete.

These two manufacturing steps can be carried out using almost the same production equipment, in that the deposition welding module on the 3D welding robot is replaced by a concrete printer module, and a concrete mass which can be processed by means of the concrete printer module is arranged on the supporting structure so as to at least partially enclose the metal reinforcement.

In a further embodiment of the method, the topology of the supporting structure digitally mapped by the component model data set can be optimized in terms of its strength, mass and design using a 3D finite element method, taking into account a biomimicry approach. Biomimicry, in this case, is the imitation of the models, systems and elements of nature for the purpose of solving complex technical problems. For the production of a supporting structure, this means that material is only deposited where it actually has to take on a supporting function. Thus, for example, beams, upper chords and lower chords of the supporting structure can have internal structures, as are known, for example, from bones.

After its completion, the supporting structure produced by the methods described above can be completed with movable components such as a step belt or a pallet belt, deflection axles, a drive shaft, a drive motor with a transmission, circulating handrail belts, guide rollers and the like, and with static or stationary components such as balustrades, comb plates, bearing points, raceways and guide rails, a controller, monitoring systems, safety systems, balustrades, cladding parts and the like, to form the finished passenger transport system. Depending on the configuration, this passenger transport system can be designed as an escalator or moving walkway.

### BRIEF DESCRIPTION OF THE DRAWINGS

Embodiments of the disclosure will be described below with reference to the accompanying drawings, with neither the drawings nor the description being intended to be interpreted as limiting the disclosure. Furthermore, the same reference signs are used for elements that are identical or have the same effect. In the drawings:

FIG. 1 schematically shows a 3D welding robot system in a first embodiment with a guide device, a 3D welding robot and a welding material feed device;

FIG. 2 schematically shows a 3D welding robot system in a second embodiment, by means of which a metal reinforcement was produced and the deposition welding module of which has been replaced by a concrete printer module in order to apply a processable concrete mass to the metal reinforcement;

FIG. 3 schematically shows a cross section through the supporting structure shown in FIG. 1; and

FIG. 4 schematically shows a further development of the 3D welding robot system shown in FIG. 1.

### DETAILED DESCRIPTION

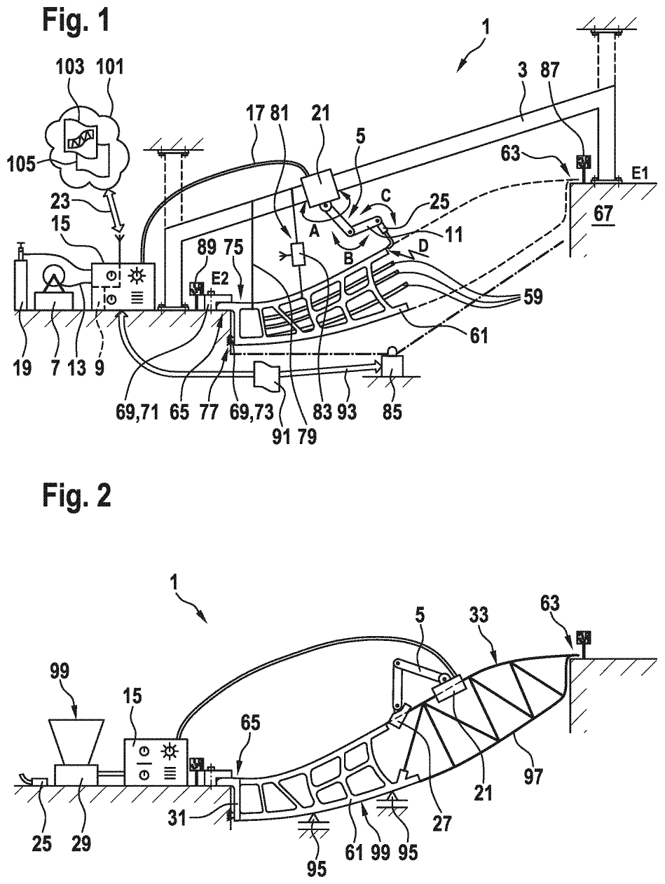

FIG. 1 schematically shows a 3D welding robot system 1 in a first embodiment with a guide device 3, a 3D welding robot 5 and a welding material feed device 7. By means of this 3D welding robot system 1, a supporting structure 61 can be constructed between two support points 63, 65 of an existing structure 67. The support points 63, 65 are formed in two floors E1, E2 of the existing structure 67 that are vertically spaced apart from one another.

In order for it to be possible to construct the supporting structure 6, the 3D welding robot system 1 also has at least one controller 9 having 3D robot control software 105. The controller 9 is integrated in a supply module 15 of the 3D welding robot system, which supply module 15 is connected to the 3D welding robot 5 via a supply line 17. This supply line 17 can be used to supply the 3D welding robot 5 with control commands from the controller 9, energy for welding, energy for moving the controlled 3D welding robot 5, and welding material 13 and optionally also a protective gas 19.

Since the 3D welding robot 5 can only reach a limited space with the robot arm 11 thereof, the 3D welding robot 5 is mounted on a traveling device 21, which can be moved passively, for example by hand, in discrete steps between the two support points 63, 65. However, the traveling device 21 is preferably configured to be active or motorized, and the traveling movements can also be controlled by the controller 9. The traveling device 21 of the present embodiment is guided on the guide device 3. For this purpose, the guide device 3 is temporarily arranged between the floors E1 and E2 and is supported thereon in the region of the support points 63, 65. As indicated by the broken lines, the guide device 3 can also be braced between floors and ceilings of the existing structure 67 in order to obtain a guide for the traveling device 21 that is as rigid and positionally stable as possible.

The supporting structure 61 to be erected is preferably mapped or defined by a digital component model data set 103. This can be, for example, a three-dimensional CAD data set of the supporting structure 61, which defines all contours, specifically both inner and outer contours. The component model data set 103 can be stored in the controller 9, for example. However, it is significantly more advantageous if, as shown by the double arrow 23 in FIG. 1, the digital component model data set 103 can be loaded into the controller 9, for example from a data cloud 101. By means of the 3D robot control software 105, which can also be stored in the data cloud 101, the digital component model data set 103 can be converted into welding operations A, B, C, D (i.e. movements of the robot arm 11, the use of the deposition welding module 25 arranged on the robot arm 11 for welding, and the feed quantity of the welding material 13) which are to be carried out by the 3D welding robot 5 during the erection phase of the supporting structure 61. Thus, during the erection phase, the supporting structure 61 is produced between the two support points 63, 65 by means of the 3D welding robot system 1 by depositing welding material.

Since local imbalances cannot be prevented due to this production method of the supporting structure 61, the portion of the supporting structure 61 that is produced first during the erection phase can be fixed to the structure 67 by means of a fixing device 69. The fixing device 69 of the present example comprises a clamping claw 71, by means of which a support bracket 75 of the supporting structure 61 that is produced by the welding operations which have already been carried out is clamped in plane E2 at the support point 65. Furthermore, the fixing device 69 comprises a support bearing 73 which supports a lower edge 77 of the supporting structure 61 against the structure 67. The fixing device 69 in particular prevents relative movements between the supporting structure 61 and the structure 67, such that no negative effects on the erection process can occur as a result. Once the supporting structure 61 is fully erected and supported at the two support points 63, 65, the parts of the fixation device 69 can be removed.

As shown in FIG. 1, the increasingly growing supporting structure 61 can also be supported in the structure 67 during production by means of suspension devices 79, 81 which are arranged between the two support points 63, 65. Furthermore, supports 95 are also possible, as shown in FIGS. 2 and 4.

FIG. 1 shows a passive suspension device 79 which supports the weight of the increasingly growing supporting structure 61 on the structure 67, in the present example via the guide device 3. An active suspension device 81 is provided in parallel therewith, the length of which can be varied by means of a cable tensioning apparatus 83. For this purpose, the cable tensioning apparatus 83 is connected to the controller 9 via a radio link. In one possible embodiment, the active cable tensioning apparatus 83 continuously transmits the tensile force in the active suspension device 81 to the controller 9, which uses this to calculate a position correction and transmits it to the cable tensioning apparatus 83, which then implements said correction by shortening the length of the active suspension device 81.

It should also be noted that the suspension devices 79, 81 and in particular remaining supports 95, as shown in FIG. 2, can also be produced by the 3D welding robot 5 as an integral component of the completed supporting structure 61 or, provided as additional components, can be integrally joined to the already produced portion of the supporting structure 61 by the 3D welding robot 5.

Furthermore, the 3D welding robot system 1 can also comprise a 3D scanner 85 and at least one reference mark 87. By means of the 3D scanner 85, the exact contours of the support points 63, 65 and the installation space between the two support points 63, 65 can be recorded before the construction of the supporting structure 61 begins and, based on this actual data, corrections can already be made to the digital component model data set 103 of the supporting structure 61 if necessary.

The reference mark 87 is preferably arranged at one of the two support points 63, 65, the 3D scanner 85, continuously or at discrete time intervals, recording the contours of the supporting structure 61 produced during the erection, together with the reference mark 85, and forwards them via a signal connection 93 (indicated symbolically by a double arrow) to the controller 9 as actual data 91. Conventional acquisition devices such as laser scanners, TOF cameras, etc. can be used as 3D scanners 85. Any known means such as reflective and patterned plates, radio transmitters and the like can be used as reference marks 85. Corrections can be made to the welding operations A, B, C, D specified by the 3D robot control software 105, in particular to the movements of the 3D welding robot 5 and the traveling device 21, by processing the actual data 91 in the controller 9. Of course, the actual data 91 can also be used to calculate the aforementioned position corrections of the active suspension device 81.

In order to allow an even more precise recording of the resulting contours of the supporting structure 61 relative to the existing structure 67, a further reference mark 89 can be arranged at the other of the two support points 65. This additional reference mark 89 is also recorded by the 3D scanner 85. The actual data 91 obtained in this way can be processed by means of triangulation algorithms, and a cloud of points representing the contours of the resulting supporting structure 61 in three-dimensional space can be generated therefrom. The data of this cloud of points can be compared with the component model data set 103 and deviations from said data set can be converted into a correction of the welding operations A, B, C, D. After completion of the supporting structure 61, the actual data 91 can be incorporated into the digital component model data set 103.

FIG. 2 schematically shows a 3D welding robot system 1 in a second embodiment. This system substantially constructs a supporting structure 61 in two work passes. In the first work pass, a metal reinforcement 97 was produced by the 3D welding robot system 1 in the same manner as the supporting structure 61 of FIG. 1. However, the metal reinforcement 97 has insufficient strength, in particular compressive strength, to support the other components of a passenger transport system 199 (see FIG. 4). In order to ultimately achieve this strength, the deposition welding module 25 of the 3D welding robot 5 was replaced by a concrete printer module 27 before the second work pass, in order to apply a processable concrete mass 99 to the metal reinforcement 97 as shown. For this purpose, the welding material feed device 7 is also replaced by a concrete feed device 29, which also feeds the processable concrete mass 99 to the concrete printer module 27 via the supply module 15.

In other words, a supporting structure 61 designed as a metal reinforcement 97 is produced by means of the 3D welding robot system 1, and the regions thereof acting as the metal reinforcement 97 are at least partially enclosed by the concrete mass 99. As soon as the concrete mass 99 has set, the supporting structure 61 is ready to receive the other components (not shown) of the passenger transport system 199 (see FIG. 4).

FIG. 2 also shows a guide for the traveling device 21 that differs from that in FIG. 1. When the metal reinforcement 97 was produced, a track 33 was also formed thereon, which is used to guide the traveling device 21. The guide device 3 shown in FIG. 1 is therefore omitted, but supports 95 have to be provided, for example, which spatially stabilize or fix the supporting structure 61 during the erection thereof in the structure 67. Of course, such a track 33 for guiding the traveling device 21 can also be formed on a framework 61 produced solely by deposition welding.

In order to simplify the production, a starting body 31 can also be present as part of the supporting structure 61 to be constructed, which starting body, as shown in FIG. 2, is arranged at one of the two support points 63, 65 or, as shown in FIG. 4, between the two support points 63, 65 of the existing structure 67 at the start of the erection of the supporting structure 61. The starting body 31 preferably has the same material properties as the welding material 13 to be deposited by the 3D welding robot system 1. A wide variety of metals, in particular, steel, but also other suitable, weldable materials such as high-strength plastics materials can be used as materials. The starting body 31 can thus be easily integrally joined to the welding material 13 to be deposited. The starting body 31 can be, for example, a flat plate, a profile bar, a beam embedded in the existing structure 67, a remaining support of the supporting structure 61 provided between the two support points 63, 65, and the like. The 3D welding robot 5 then deposits the welding material 13, starting at the starting body 31, and thus builds up the supporting structure 61.

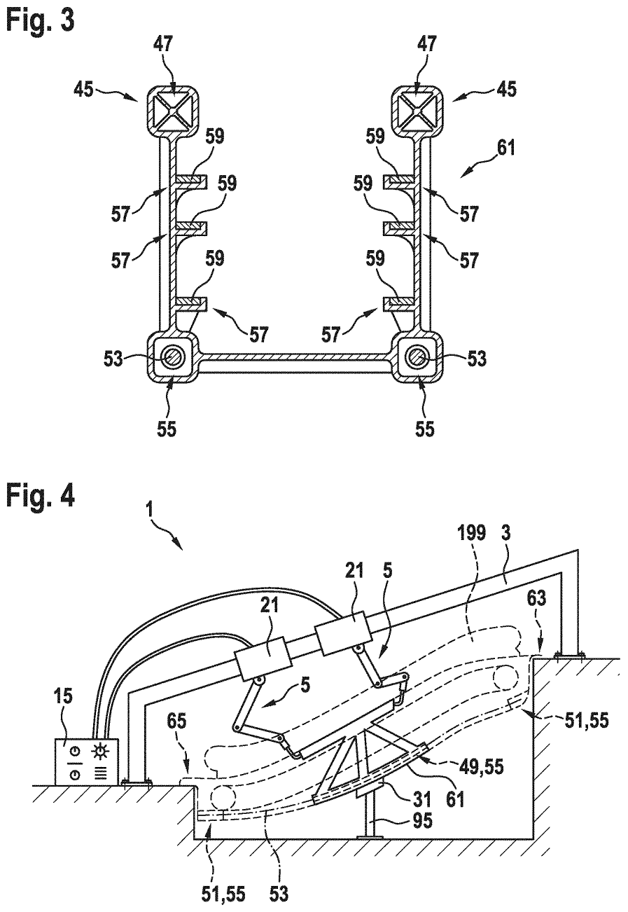

FIG. 3 schematically shows a cross section through the supporting structure 61 shown in FIG. 1. The fastening regions 57 for further components of the passenger transport system 199, which were also formed on the supporting structure 61 during the production thereof, can be clearly seen here. In the present example, the fastening regions 57 are used to accommodate guide rail inserts 59 (see also FIG. 1). Of course, the guide rail inserts 59 can also be inserted continuously during the erection of the supporting structure 61 and, if necessary, directly welded in with the supply of welding material 13. These inserts could then also be used as a track 33 for the traveling device 21.

As FIGS. 3 and 4 also show, receptacles 55 for tensioning elements 53 can also be formed on the supporting structure 61 during the production thereof. Such tensioning elements 53 can be, for example, steel cables, steel wires, steel rods and the like, which, for example, have tensioning fittings having threaded attachments at the ends thereof, such that said elements can be arranged between the receptacles 55 and tensioned, analogously to prestressed concrete structures, at least after the receptacles 55 have been produced. In this case, some of the receptacles are used as anchoring points 51 and others are used as a tensioning element guide 49.

As already mentioned in connection with FIG. 1, the supporting structure 61 to be erected or the contours and internal structure thereof is defined by a digital component model data set 103. The topology of this digital component model data set 103 of the supporting structure 61 can be optimized with regard to strength, mass and design using a 3D finite element method, taking into account a biomimicry approach. As a result, internal structures 47 which can only be produced using the method according to the disclosure can also be automatically defined. The internal structures 47 shown in FIG. 3 and formed in the upper chords 45 of the supporting structure 61 are only to be understood as exemplary. In an actual embodiment, these structures 47 are designed using the 3D finite element method, taking into account the biomimicry approach, on the basis of the tensile, compressive, bending and torsional stresses that occur there.

FIG. 4 schematically shows a possible development of the 3D welding robot system 1 shown in FIG. 1. In this variant, two 3D welding robots 5 with the traveling devices 21 associated therewith are guided on the guide device 3. In this case, the two 3D welding robots 5 are supplied by the same supply module 15. A remaining support 95 which is arranged between the two support points 63, 65 of the existing structure 67 is used as the starting body 31. This development not only allows the manufacturing time to be halved, but also allows a statically balanced erection of the supporting structure 61, such that the use of suspension devices 79, 81 and fixing devices 69 (not shown) can be minimized As already mentioned above, the receptacles 55 for a tensioning element 53, which are designed as anchoring points 51 and clamping element guides 49, are also shown in FIG. 4.

As soon as the supporting structure 61 has been erected by means of the method according to the disclosure, certain contours, such as fastening regions, receptacles and the like, may have to be reworked using additional production methods such as grinding, milling and drilling. Thereafter, as shown schematically by the broken lines, further static and movable components of the passenger transport system 199 configured as an escalator or moving walkway can be installed in and on the completed supporting structure 61. The completed passenger transport system 199 can then be put into operation.

Although FIGS. 1 to 4 show different aspects of the present disclosure on the basis of a concrete structure 61 to be constructed, which is intended to interconnect floors E1, E2, which are at a vertical distance from one another, it is obvious that the method steps described and a corresponding device are equally suitable for supporting structures 61 to be arranged on one plane, such as are used for moving walkways, for example. In addition, the concrete printing module 27 can have further functional units such as a device for smoothing surfaces, by means of which the surfaces of the processed concrete mass 99 of the supporting structure 61, which has not yet set, can be processed. In order to protect the welded supporting structure 61 from corrosion, the welding module 25 can be replaced by a spray module (not shown) after the completion of the metal framework structure. This spray module can apply a precise and even surface coating, which can be single or multi-layer depending on requirements.

Finally, it should be noted that terms such as “comprising,” “having,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above. Reference signs in the claims should not be considered to be limiting.

1. A method for erecting a supporting structure of a passenger transport system configured as an escalator or moving walkway, the method comprising:
constructing the supporting structure between two support points of an existing structure using a 3D welding robot system, the 3D welding robot system comprising:
at least one controller having 3D robot control software,
a traveling device having a 3D welding robot, and a welding material feed device,
wherein a component model data set that digitally maps the supporting structure is converted into welding operations using the 3D robot control software,
wherein the welding operations are carried out by the 3D welding robot during an erection phase of the supporting structure,
wherein the supporting structure being is produced between the two support points using the 3D welding robot system by depositing welding material during the erection phase, and
wherein at least one of fastening regions for further components of the passenger transport system and bedding for guide rail inserts are also formed on the supporting structure during the production thereof.

2-14. (canceled)

15. The method of claim 1, wherein a starting body is provided as part of the supporting structure to be constructed, the starting body arranged at one of the two support points or between the two support points of the existing structure at the start of the erection of the supporting structure, and wherein the 3D welding robot builds up the supporting structure starting from the starting body.

16. The method of claim 1, wherein a portion of the supporting structure that is produced first during the erection phase is fixed to the structure using a fixing device.

17. The method of claim 1, wherein the 3D welding robot system further comprises a 3D scanner and at least one reference mark, the reference mark arranged at one of the two support points, wherein the 3D scanner:
continuously or at discrete time intervals, records contours of the supporting structure produced during the erection, together with the reference mark, and
forwards the recorded contours to the controller as actual data, wherein corrections can be made to the welding operations of the 3D welding robot that are specified by the 3D robot control software by processing the actual data in the controller.

18. The method claim 14, wherein a further reference mark is arranged at the other of the two support points, and the further reference mark is also recorded by the 3D scanner.

19. The method of claim 1, wherein the 3D welding robot system further comprises a guide device that can be set up temporarily and is arranged between the two support points during the production of the supporting structure and on which the traveling device is guided.

20. The method of claim 1, wherein, during the production of the supporting structure, a track is also formed thereon that is used to guide the traveling device.

21. The method of claim 1, wherein, during the production of the supporting structure, receptacles for tensioning elements are also formed thereon and, at least after the production of the receptacles, tensioning elements are arranged and tensioned between the receptacles.

22. The method of claim 1, wherein, during the production of the supporting structure, am already produced portion of the supporting structure is supported in the structure using at least one of supports and suspension devices.

23. The method of claim 9, wherein the at least one of the supports and suspension devices are produced by the 3D welding robot as an integral component of the completed supporting structure, or, provided as additional components, are integrally joined to the already produced portion of the supporting structure by the 3D welding robot.

24. The method of claim 1, wherein a supporting structure designed as a metal reinforcement is produced using the 3D welding robot system, and the regions thereof acting as the metal reinforcement are at least partially enclosed by a concrete mass.

25. The method of claim 11, wherein a deposition welding module on the 3D welding robot is replaced by a concrete printer module and concrete mass which can be processed by the concrete printer module is arranged on the supporting structure so as to at least partially enclose the metal reinforcement.

26. The method of claim 1, wherein a topology of the supporting structure digitally mapped by the component model data set is optimized in terms of its strength, mass and design using a 3D finite element method, based on a biomimicry approach.

27. A passenger transport system that configured as an escalator or moving walkway, comprising a supporting structure manufactured according to the method of claim 1 and other components of the passenger transport system that are statically or movably arranged in this supporting structure.
